(19) United States
(12) Patent Application Publication
(10) Pub. No.: US 2021/0147623 A1
(43) Pub. Date: May 20, 2021

(54) PROCESS FOR THE PREPARATION OF FUNCTIONALIZED POLYOXYALKYLENE POLYOLS

(71) Applicant: Covestro Deutschland AG, Leverkusen (DE)

(72) Inventors: Thomas Ernst Mueller, Aachen (DE); Christoph Guertler, Köln (DE); Daniela Cozzula, Sankt Katharinen (DE); Burkhard Köhler, Zierenberg (DE); Muhammad Afzal Subhani, Aachen (DE); Walter Leitner, Aachen (DE)

(21) Appl. No.: 16/628,165

(22) PCT Filed: Jun. 27, 2018
(86) PCT No.: PCT/EP2018/067214

§ 371 Date: Jan. 2, 2020

(30) Foreign Application Priority Data
Jul. 7, 2017 (EP) 17180273.9

(51) Int. Cl. C08G 65/26; C08G 65/24; C08G 18/50; C08G 18/44

(52) U.S. Cl. CPC C08G 65/2663; C08G 18/44; C08G 18/5009; C08G 65/24

(57) ABSTRACT

A process for preparing halogen-containing polyoxyalkylenepolyols, comprising the step of reacting an alkylene oxide with carbon dioxide in the presence of an H-functional starter compound and of a double metal cyanide catalyst, wherein the reaction is also conducted in the presence of an α,β-epoxy-γ-haloalkane.

The present invention relates to a process for preparing polyoxyalkylenepolyols, comprising the step of reacting an alkylene oxide with carbon dioxide in the presence of an H-functional starter compound and of a double metal cyanide catalyst, wherein the reaction is also conducted in the presence of an α,β-epoxy-γ-haloalkane.

Preparation of polyethercarbonate polyols by catalytic reaction of alkylene oxides (epoxides) and carbon dioxide in the presence of H-functional starter substances (“starters”) has been the subject of intensive study for more than 40 years (e.g. Inoue et al., Copolymerization of Carbon Dioxide and Alkylenoxide with Organometallic Compounds; Die Makromolekulare Chemie [Macromolecular Chemistry] 130, 210-220, 1969). This reaction is environmentally very advantageous, since it constitutes the conversion of a greenhouse gas such as CO₂ to a polymer.

One example of more recent studies is patent application WO 2015/14732 A1, which discloses a process for preparing polyethercarbonate polyols. One or more alkylene oxide(s) and carbon dioxide are added onto one or more H-functional starter substance(s) in the presence of a double metal cyanide catalyst or in the presence of a metal complex catalyst based on the metals zinc and/or cobalt to obtain a reaction mixture comprising the polyethercarbonate polyol. At least one component K is added to the reaction mixture obtained, comprising the polyethercarbonate polyol, where component K is selected from at least one compound containing a phosphorus-oxygen bond or a compound of phosphorus that can form one or more P—O bonds by reaction with OH-functional compounds.

Epichlorohydrin is used for production of rubber. A distinction is made here between three different elastomer types: epichlorohydrin homopolymer (CO), epichlorohydrin/ethylene oxide copolymer (ECO) and epichlorohydrin terpolymers that are formed from epichlorohydrin, ethylene oxide and a further monomer, typically an unsaturated epoxide such as allyl glycidyl ether. The features of epichlorohydrin-based rubbers include stability toward oils, fuels and chemicals.

A further subject of research is the copolymerization of epichlorohydrin as a functionalized epoxide with carbon dioxide. Donald J. Darensbourg et al. describe, in J. Am. Chem. Soc. 2011, 133, 15191-15199, the strictly alternating copolymerization of carbon dioxide and epichlorohydrin in the presence of (salen)cobalt(III) catalysts. In Macromolecules 2013, 46, 2128-2133, Donald J. Darensbourg et al. report a crystalline epichlorohydrin-C02 copolymer via Co(III)-mediated stereospecific polymerization.

Polymer (2013) 54(23) 6357-6362 describes the conversion of epichlorohydrin under DMC catalysis to a polymer. The polyether has a T_{g} of −38.6° C., which is too high for some PU applications. Likewise described is the reaction of epichlorohydrin with carbon dioxide under DMC catalysis. The CO₂ incorporation rate varies between 37.8% and 70.7%, and the T_{g}s between −16.9° C. and +31.2° C., too high for PU applications. There is no mention of the use of hydroxy-functional starters, which means that the molar masses are not controllable. 0.67% by weight of DMC catalyst is used, a large amount of catalyst which, if not removed, can impair properties such as hydrolysis stability or optical clarity. The reaction proceeds satisfactorily only at low temperatures, which entails long reaction times of 48-132 h. The breakdown temperature of 250° C. is not satisfactory either.

RCS Advances (2014) 4(42) 21765-21771 (ordered from Bayer). By use of optically active epichlorohydrin, semicrystalline polyethers are obtained, which is unsuitable for polyol applications. There is no mention of the use of hydroxy-functional starters.

Macromolecules (2016) 49 (8) 2971-2976 describes the synthesis of an alternating copolymer from optionally enantiomerically pure epichlorohydrin and COS in the presence of (salen)Cr(III) complexes. When enantiomerically pure epichlorohydrin is used, a semicrystalline polymer is obtained with a melting point of 96.7° C., which is unsuitable for PU applications, but the glass transition temperature Tg of 15.6° C. is also too high, and the products all contain sulfur, which is undesirable for many applications.

The synthesis of an alternating C02-epichlorohydrin copolymer under zinc glutarate catalysis is described in Macromolucular Rapid Communications (2016) 37 (9) 788-793. The glass transition temperature Tg is 44° C., which is unsuitable for PU applications.

J. Mol. Catal. A (2013) 379 38-45 describes the synthesis of the cyclic carbonate from epichlorohydrin and carbon dioxide using DMC catalysts and quaternary ammonium salts as cocatalysts.

It would be desirable to incorporate epichlorohydrin or other α,β-epoxy-γ-haloalkanes into alkylene oxide-based polyethercarbonates. Polyols functionalized in this way may serve as raw materials for increasing the stability or improving other properties of polyurethane polymers. It is likewise possible for such functionalized polyols to serve as intermediates for the introduction of further functions into the polyols.

The prior art frequently mentions epichlorohydrin as a possible monomer for preparation of polyethercarbonate polyols. This is done in the form of long lists in which many different alkylene oxides considered to be suitable for the invention claimed in each case are enumerated. The use of epichlorohydrin as a comonomer alongside unfunctionalized alkylene oxides in polyethercarbonate synthesis has not been described to date.

It is therefore an object of the present invention to provide a process by which such polyoxyalkylenepolyols functionalized in the side chains can be obtained, with use of smaller amounts of catalyst and within shorter reaction times.

The object is achieved in accordance with the invention by a process for preparing polyoxyalkylenepolyols, comprising the step of reacting an alkylene oxide with carbon dioxide in the presence of an H-functional starter compound and of a double metal cyanide catalyst, wherein the reaction is also conducted in the presence of an α,β-epoxy-γ-haloalkane.

The reaction is shown by way of example by the following reaction scheme:

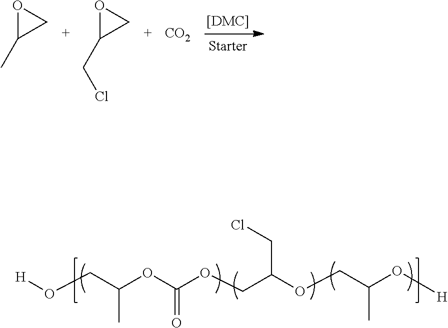

It has been found that α,β-epoxy-γ-haloalkanes and other epoxides can be copolymerized with CO₂ under DMC catalysis, forming a polyoxyalkylenepolyol having halogen substitution in the side chain, which can be reacted with a phosphinite, phosphonite and/or phosphite in a Michaelis-Arbuzov reaction to give a phosphorus-containing polyoxyalkylenepolyol.

The object is achieved in accordance with the invention by a process for preparing polyethercarbonate polyols, comprising the steps of:
(α) initially charging a catalyst and
(αα) a suspension medium which contains no H-functional groups
and/or
(αβ) an H-functional starter compound
(β) metering in at least one epoxide in the presence of carbon dioxide, where the epoxide(s) metered in in step (γ) may be the same as or different from the epoxide or epoxides metered in in step (β) and where step (β) is conducted between step (α) and step (γ),
(γ) metering in carbon dioxide and at least two alkylene oxides, where these alkylene oxides may be the same as or different from the alkylene oxide or oxides metered in in step (β),

where at least one of the alkylene oxides metered in in stage (γ) is an α,β-epoxy-γ-haloalkane and at least one of the alkylene oxides metered in in stage (γ) is halogen-free, and where, in addition, if no H-functional starter compound has been initially charged in step (α), step (γ) comprises the metered addition of a H-functional starter compound and the catalyst is a double metal cyanide catalyst.

A preferred embodiment of the process usable in accordance with the invention for preparing the polyethercarbonate polyols from one or more H-functional starter compounds, two or more alkylene oxides and carbon dioxide in the presence of a DMC catalyst is characterized in that

(α) [first activation stage] a suspension medium containing no H-functional groups, an H-functional starter compound, a mixture of a suspension medium containing no H-functional groups and an H-functional starter compound, or a mixture of at least two H-functional starter compounds is initially charged, and water and/or other volatile compounds are optionally removed by elevated temperature and/or reduced pressure, where the DMC catalyst is added to the suspension medium, to the H-functional starter compound, or to the mixture of at least two H-functional starter compounds, before or after the 1st activation stage,

(β) [second activation stage] a portion (based on the total amount of the amount of alkylene oxides used in steps (β) and (γ)) of one or more alkylene oxides is added to the mixture resulting from step (α), where the addition of a portion of alkylene oxides can optionally be effected in the presence of CO₂ and/or inert gas (such as nitrogen or argon, for example), and where step (β) can also be effected twice or more,

(γ) [polymerization stage] for the construction of a polyethercarbonate polyol polymer chain, a mixture of two or more alkylene oxides, where at least one is an α,β-epoxy-γ-haloalkane, and carbon dioxide are metered constantly into the mixture resulting from step (3), where the alkylene oxides used for the terpolymerization may be the same as or different from the alkylene oxides used in step (3).

Step (α):

The individual components in step (α) can be added simultaneously or in succession in any order; preferably, in step (α), the DMC catalyst is introduced initially, and, subsequently or at the same time, suspension medium containing no H-functional groups, the H-functional starter compound, the mixture of a suspension medium containing no H-functional groups and the H-functional starter compound, or the mixture of at least two H-functional starter compounds is added. Two or more catalysts from the group of the DMC catalysts may also be used.

A preferred embodiment provides a process wherein, in step (α),

(α1) a reactor is charged with the DMC catalyst and suspension medium containing no H-functional groups, and/or with one or more H-functional starter compounds,

(α2) an inert gas (for example nitrogen or a noble gas such as argon), an inert gas-carbon dioxide mixture or carbon dioxide is passed through the reactor at a temperature of 50 to 200° C., preferably of 80 to 160° C., more preferably of 125 to 135° C., and, at the same time, a reduced pressure (in absolute terms) of 10 mbar to 800 mbar, preferably of 40 mbar to 200 mbar, is established in the reactor by removing the inert gas or carbon dioxide (for example with a pump) [first activation stage].

A further preferred embodiment provides a process wherein, in step (α),

(α1) suspension medium containing no H-functional groups, the H-functional starter compound and/or a mixture of at least two H-functional starter compounds is initially charged, optionally under an inert gas atmosphere (for example nitrogen or argon), under a mixed inert gas/carbon dioxide atmosphere, or under a pure carbon dioxide atmosphere, more preferably under an inert gas atmosphere, and

(α2) an inert gas (for example nitrogen or a noble gas such as argon), an inert gas-carbon dioxide mixture or carbon dioxide, more preferably an inert gas (for example nitrogen or argon), is introduced into the resulting mixture of DMC catalyst and suspension medium containing no H-functional groups and/or one or more H-functional starter compounds at a temperature of 50 to 200° C., preferably of 80 to 160° C., more preferably of 125 to 135° C., and at the same time, by removing the inert gas or carbon dioxide (with a pump, for example), a reduced pressure (absolute) of 10 mbar to 800 mbar, preferably of 40 mbar to 200 mbar, is set in the reactor [first activation stage], with addition of the double metal cyanide catalyst to the suspension medium containing no H-functional groups, to the H-functional starter compound, to the mixture of a suspension medium containing no H-functional groups and the H-functional starter compound or the mixture of at least two H-functional starter compounds in step (α1) or immediately thereafter in step (α2).

The DMC catalyst can be added in solid form or in a suspension medium which comprises no H-functional groups, or in suspension in one or more H-functional starter compounds. If the DMC catalyst is added as a suspension, it is added preferably in step (α1) to the suspension medium and/or to the one or more H-functional starter compounds.

Step (β):

Step (β) of the second activation stage may take place in the presence of CO₂ and/or inert gas (such as nitrogen or argon, for example). Step (β) preferably takes place under an atmosphere composed of an inert gas/carbon dioxide mixture (nitrogen/carbon dioxide or argon/carbon dioxide, for example) or a carbon dioxide atmosphere, more preferably under a carbon dioxide atmosphere. The establishment of an inert gas/carbon dioxide atmosphere or a carbon dioxide atmosphere and the metering of one or more alkylene oxides may take place in principle in different ways. The supply pressure is preferably established by introduction of carbon dioxide, where the pressure (in absolute terms) is 10 mbar to 100 bar, preferably 100 mbar to 50 bar and especially preferably 500 mbar to 50 bar. The start of the metering of the alkylene oxide or oxides may take place at a supply pressure selected arbitrarily beforehand. The overall pressure (absolute) of the atmosphere is adjusted in step (β) preferably in the range from 10 mbar to 100 bar, preferably 100 mbar to 50 bar, and further preferably 500 mbar to 50 bar. Optionally, during or after the metering of the alkylene oxide, the pressure is under closed-loop control by introduction of further carbon dioxide, with the pressure (absolute) being 10 mbar to 100 bar, preferably 100 mbar to 50 bar, and more preferably 500 mbar to 50 bar.

In a further embodiment, the amount of one or more alkylene oxides used in the activation in step (β) may be 0.1 to 25.0% by weight, preferably 1.0 to 20.0% by weight, more preferably 2.0 to 16.0% by weight, based on the amount of suspension medium containing no H-functional groups used in step (α), or of H-functional starter compound. The alkylene oxide can be added in one step or stepwise in two or more portions.

In one additional embodiment of the invention, during the activation in step (β), a portion (relative to the total amount of the amount of alkylene oxides used in steps (β) and (γ)) of one or more alkylene oxides is added to the mixture resulting from step (α) [second activation stage]. This addition of a portion of alkylene oxides may take place optionally in the presence of CO₂ and/or inert gas. Step (β) may also take place more than once. The DMC catalyst is preferably used in an amount such that the amount of DMC catalyst in the resulting polyethercarbonate polyol is 10 to 10 000 ppm, more preferably 20 to 5000 ppm, and most preferably 50 to 500 ppm.

In the second activation step, the alkylene oxide or oxides may be added, for example, in one portion, over the course of 1 to 15 minutes or, preferably, over the course of 5 to 10 minutes. The duration of the second activation step is preferably 15 to 240 minutes, more preferably 20 to 60 minutes.

Step (γ):

The metered addition of the halogen-free and halogen-containing alkylene oxides and of the carbon dioxide can be effected simultaneously, alternately or sequentially, where the halogen-containing alkylene oxide is added only in the presence of CO₂. Preferably, the metered addition of halogen-containing alkylene oxide does not commence until at least 10-15% of the amount of epoxide has been added. The required amount of carbon dioxide may be added all at once or metered over the reaction time. It is possible during the addition of the alkylene oxides to raise or to lower the CO₂ pressure, gradually or in steps, or to leave it the same. Preferably, the total pressure is kept constant during the reaction by metered addition of further carbon dioxide. The metering of the alkylene oxide or oxides and of the CO₂ may take place simultaneously, alternately or sequentially to the metering of carbon dioxide. The alkylene oxide or oxides can be metered with a constant rate, or the metering rate may be raised or lowered continuously or in steps, or the alkylene oxide or oxides may be added in portions. Preferably, the alkylene oxide is added to the reaction mixture at a constant metering rate. A plurality of alkylene oxides may be metered in individually or as a mixture. The metered addition of the alkylene oxides can be effected simultaneously, alternately or sequentially, each via separate metering points (addition points), or via one or more metering points, in which case the alkylene oxides can be metered in individually or as a mixture. Via the nature and/or sequence of the metering of the alkylene oxides and/or of the carbon dioxide it is possible to synthesize random, alternating, blocklike or gradientlike polyethercarbonate polyols of low viscosity that have side chains.

Preference is given to using an excess of carbon dioxide, relative to the calculated amount of carbon dioxide required in the polyethercarbonate polyol, since an excess of carbon dioxide is an advantage because of the reactive inertia of carbon dioxide. The amount of carbon dioxide can be specified by way of the total pressure. A total pressure (absolute) which has proven advantageous is the range from 0.01 to 120 bar, preferably 0.1 to 110 bar, more preferably from 1 to 100 bar for the copolymerization for preparing the low-viscosity polyethercarbonate polyols having side chains. It is possible to supply the carbon dioxide to the reaction vessel continuously or discontinuously. This depends on how quickly the alkylene oxides and the CO₂ are consumed and on whether the product is to include any CO₂-free polyether blocks or blocks having a different CO₂ content. The concentration of carbon dioxide may also be varied during the addition of the alkylene oxides. Depending on the reaction conditions selected, it is possible for the CO₂ to be introduced into the reactor in the gaseous, liquid or supercritical state. CO₂ may also be added to the reactor as a solid and then converted to the gaseous, dissolved, liquid and/or supercritical state under the chosen reaction conditions.

In step (γ), the carbon dioxide can be introduced into the mixture, for example, by

(i) sparging the reaction mixture in the reactor from below,

(ii) using a hollow-shaft stirrer,

(iii) a combination of metering forms as per (i) and (ii), and/or

(iv) sparging via the surface of the liquid, by using multilevel stirring elements.

The sparging of the reaction mixture in the reactor as per (i) is preferably effected by means of a sparging ring, a sparging nozzle, or by means of a gas inlet tube. The sparging ring is preferably an annular arrangement or two or more annular arrangements of sparging nozzles, preferably arranged at the base of the reactor and/or on the side wall of the reactor.

The hollow-shaft stirrer as per (ii) is preferably a stirrer in which the gas is introduced into the reaction mixture via a hollow shaft in the stirrer. The rotation of the stirrer in the reaction mixture (i.e. in the course of mixing) gives rise to a reduced pressure at the end of the stirrer paddle connected to the hollow shaft, such that the gas phase (containing CO₂ and any unconsumed alkylene oxide) is sucked out of the gas space above the reaction mixture and is passed through the hollow shaft of the stirrer into the reaction mixture.

The sparging of the reaction mixture as per (i), (ii), (iii) or (iv) can be effected with freshly metered-in carbon dioxide in each case and/or may be combined with a suctioning of the gas out of the gas space above the reaction mixture and subsequent recompression of the gas. For example, the gas suctioned off from the gas space above the reaction mixture and compressed, optionally mixed with fresh carbon dioxide and/or alkylene oxide, is introduced again into the reaction mixture as per (i), (ii), (iii) and/or (iv).

The pressure drop which comes about via incorporation of the carbon dioxide and of the alkylene oxides into the reaction product during the terpolymerization is preferably compensated by freshly metered-in carbon dioxide.

The alkylene oxides can be introduced separately or together with the CO₂, either above the liquid surface or directly into the liquid phase. The alkylene oxides are preferably introduced directly into the liquid phase, since this has the advantage of rapid mixing of the introduced alkylene oxide with the liquid phase, thereby preventing local peaks in concentration of alkylene oxides. The introduction into the liquid phase can be effected via one or more inlet tubes, one or more nozzles or one or more annular arrangements of multiple metering points, which are preferably arranged at the base of the reactor and/or at the side wall of the reactor.

The three steps (α), (β) and (γ) can be performed in the same reactor, or each can be performed separately in different reactors. Particularly preferred reactor types are stirred tanks, tubular reactors, and loop reactors. Where reaction steps (α), (β), and (γ) are carried out in different reactors, a different type of reactor can be used for each step.

Polyethercarbonate polyols with side chains can be prepared in a backmixed reactor, such as a stirred tank or a loop reactor; depending on embodiment and mode of operation, the stirred tank or loop reactor is cooled via the reactor shell, via internal cooling surfaces and/or via cooling surfaces within a pumped circulation system. Both in semibatchwise application, in which the product is not removed until after the end of the reaction, and in continuous application, in which the product is removed continuously, particular attention should be paid to the metering rate of the alkylene oxide. This should be set such that, in spite of the inhibiting action of the carbon dioxide, the alkylene oxides are depleted quickly enough. The concentration of free alkylene oxides in the reaction mixture during the second activation stage (step β) is preferably >0 to <100% by weight, more preferably >0 to ≤50% by weight, very preferably >0 to ≤20% by weight (based in each case on the weight of the reaction mixture). The concentration of free alkylene oxides in the reaction mixture during the reaction (step γ) is preferably >0 to ≤40% by weight, more preferably >0 to ≤25% by weight, most preferably >0 to ≤15% by weight (based in each case on the weight of the reaction mixture).

In a further embodiment of the stirred tank for the copolymerization (step γ), one or more H-functional starter compounds may also be metered into the reactor continuously during the reaction. The amount of the H-functional starter compounds metered into the reactor continuously during the reaction is preferably at least 20 mol % equivalents, more preferably 70 to 95 mol % equivalents (based in each case on the total amount of H-functional starter compounds). In the case of continuous performance of the process, the amount of the H-functional starter compounds which are metered continuously into the reactor during the reaction is preferably at least 80 mol % equivalents, more preferably 95 to 100 mol % equivalents (based in each case on the total amount of H-functional starter compounds).

In a preferred embodiment, the catalyst-starter mixture activated as per steps (α) and (β) is reacted further with alkylene oxides and carbon dioxide in the same reactor. In a further preferred embodiment, the catalyst-starter mixture activated as per steps (α) and (β) is reacted further with alkylene oxides and carbon dioxide in another reaction vessel (for example a stirred tank, tubular reactor or loop reactor). In another preferred embodiment, the mixture prepared as per step (α) is reacted in a different reaction vessel (for example, a stirred tank, tubular reactor, or loop reactor) with alkylene oxides and carbon dioxide as per steps (β) and (γ).

In the case of reaction carried out in a tubular reactor, the mixture prepared as per step (α) or the mixture activated as per steps (α) and (β), and optionally starters and also alkylene oxides and carbon dioxide, are pumped continuously through a tube. When a mixture prepared according to step (α) is used, the second activation stage of step (β) takes place in the first part of the tubular reactor, and the terpolymerization as per step (γ) takes place in the second part of the tubular reactor. The molar ratios of the co-reactants may vary according to the desired polymer.

In a preferred embodiment, carbon dioxide is metered in here in its liquid or supercritical form, in order to enable optimal miscibility of the components. The carbon dioxide can be introduced into the reactor at the entrance to the reactor and/or via metering points arranged along the reactor. A portion of the alkylene oxides may be introduced at the inlet of the reactor. The remaining amount of the alkylene oxides is preferably introduced into the reactor via a plurality of metering points arranged along the reactor. Mixing elements of the kind sold, for example, by Ehrfeld Mikrotechnik BTS GmbH are advantageously installed for more effective mixing of the co-reactants, or mixer-heat exchanger elements, which at the same time improve mixing and heat removal. The mixing elements preferably mix metered-in CO₂ and/or alkylene oxides with the reaction mixture. In an alternative embodiment, different volume elements of the reaction mixture can be mixed with one another.

Loop reactors or stirred tanks operated continuously or batchwise may likewise be used for preparing halogen-containing polyethercarbonate polyols. These generally include reactors having internal and/or external material recycling (optionally with heat exchanger surfaces arranged in the circulation system), for example a jet loop reactor or Venturi loop reactor, which can also be operated continuously, or a tubular reactor designed in the form of a loop with suitable apparatuses for the circulation of the reaction mixture, or a loop of several series-connected tubular reactors or a plurality of series-connected stirred tanks.

Where reaction takes place in a continuously operated stirred tank or in a loop reactor, the reactants are pumped continuously through a continuously operating stirred tank or a loop reactor. When a mixture prepared as per step (α) is used, the second activation stage as per step (β) takes place simultaneously with the terpolymerization of step (γ) in the continuously operated stirred tank or in a loop reactor. The molar ratios of the co-reactants may vary according to the desired polymer. The use of a continuously operated stirred tank or loop reactor is especially advantageous because in this case, in step (γ) or in steps (β) and (γ), backmixing can be achieved, and so the concentration of free alkylene oxides in the reaction mixture can be kept within the optimum range, preferably within the range of >0% to ≤40% by weight, more preferably >0% to ≤25% by weight, most preferably >0% to ≤15% by weight (based in each case on the weight of the reaction mixture). Furthermore, the use of a continuously operated stirred tank or of a loop reactor has the advantage that the side chains are incorporated into the polymer chain randomly with consistent probability, producing particularly advantageous product properties such as particularly low viscosities, for example.

The polyethercarbonate polyols are preferably prepared in a continuous process. This process may comprise either a continuous copolymerization or else a continuous addition of the one or more H-functional starter substances. The invention therefore also provides a process wherein, in step (γ), one or more H-functional starter substance(s), DMC catalyst and at least two alkylene oxide(s), where at least one is halogen-containing, are metered continuously into the reactor in the presence of carbon dioxide (“copolymerization”), and where a portion of the resulting reaction mixture (comprising the reaction product) is removed continuously from the reactor. Preferably, in step (γ), the DMC catalyst is added continuously in suspension in H-functional starter compound.

The term “continuously” used here can be defined as the mode of addition of a relevant catalyst or reactant such that an essentially continuous effective concentration of the DMC catalyst or the reactant is maintained. The catalyst can be fed in in a truly continuous manner or in relatively closely spaced increments. Equally, a continuous addition of starter can be effected in a truly continuous manner or in increments. There would be no departure from the present process in adding a DMC catalyst or reactants incrementally such that the concentration of the materials added drops essentially to zero for a period of time before the next incremental addition. However, it is preferable for the DMC catalyst concentration to be kept substantially at the same concentration during the main portion of the course of the continuous reaction, and for starter substance to be present during the main portion of the copolymerization process. An incremental addition of DMC catalyst and/or reactant which does not substantially influence the nature of the product is nevertheless “continuous” in that sense in which the term is being used here. It is possible, for example, to provide a recycling loop in which a portion of the reacting mixture is recycled to a prior point in the process, thus smoothing out discontinuities caused by incremental additions.

In order to achieve full conversion, the reaction apparatus in which step (γ) is carried out may frequently be followed by a further tank or a tube (“delay tube”) in which residual concentrations of free alkylene oxides present after the reaction are depleted by reaction. Preferably, the pressure in this downstream reactor is at the same pressure as in the reaction apparatus in which reaction step (γ) is performed. The pressure in the downstream reactor can, however, also be selected at a higher or lower level. In a further preferred embodiment, the carbon dioxide, after reaction step (γ), is fully or partly released and the downstream reactor is operated at standard pressure or a slightly elevated pressure. The temperature in the downstream reactor is preferably 10° C. to 150° C. and more preferably 20° C. to 100° C. At the end of the post-reaction time or at the outlet of the downstream reactor, the reaction mixture may contain preferably less than 0.05% by weight of alkylene oxides. The post-reaction time or the residence time in the downstream reactor is preferably 10 min to 24 h, especially preferably 10 min to 3 h.

The suspension media which are used in step (α) for suspending the catalyst contain no H-functional groups. Suitable suspension media are any polar aprotic, weakly polar aprotic and nonpolar aprotic solvents, none of which contain any H-functional groups. The suspension media used may also be a mixture of two or more of these suspension media. The following polar aprotic solvents are mentioned here by way of example: 4-methyl-2-oxo-1,3-dioxolane (also referred to below as cyclic propylene carbonate), 1,3-dioxolan-2-one, acetone, methyl ethyl ketone, acetonitrile, nitromethane, dimethyl sulfoxide, sulfolane, dimethylformamide, dimethylacetamide and N-methylpyrrolidone. The group of the nonpolar aprotic and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferred suspension media are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

In one alternative embodiment, suspension media used in step (α) for suspending the catalyst are one or more compounds selected from the group consisting of aliphatic lactones, aromatic lactones, lactides, cyclic carbonates having at least three optionally substituted methylene groups between the oxygen atoms of the carbonate group, aliphatic cyclic anhydrides, and aromatic cyclic anhydrides. Without being tied to a theory, suspension media of this kind are incorporated into the polymer chain in the subsequent course of the ongoing polymerization in the presence of a starter. As a result, there is no need for downstream purification steps.

Aliphatic or aromatic lactones are cyclic compounds containing an ester bond in the ring. Preferred compounds are 4-membered-ring lactones such as β-propiolactone, β-butyrolactone, β-isovalerolactone, β-caprolactone, β-isocaprolactone, β-methyl-β-valerolactone, 5-membered-ring lactones, such as γ-butyrolactone, γ-valerolactone, 5-methylfuran-2(3H)-one, 5-methylidenedihydrofuran-2(3H)-one, 5-hydroxyfuran-2(5H)-one, 2-benzofuran-1(3H)-one and 6-methyl-2-benzofuran-1(3H)-one, 6-membered-ring lactones, such as δ-valerolactone, 1,4-dioxan-2-one, dihydrocoumarin, 1H-isochromen-1-one, 8H-pyrano[3,4-b]pyridin-8-one, 1,4-dihydro-3H-isochromen-3-one, 7,8-dihydro-5H-pyrano[4,3-b]pyridin-5-one, 4-methyl-3,4-dihydro-1H-pyrano[3,4-b]pyridin-1-one, 6-hydroxy-3,4-dihydro-1H-isochromen-1-one, 7-hydroxy-3,4-dihydro-2H-chromen-2-one, 3-ethyl-1H-isochromen-1-one, 3-(hydroxymethyl)-1H-isochromen-1-one, 9-hydroxy-1H,3H-benzo[de]isochromen-1-one, 6,7-dimethoxy-1,4-dihydro-3H-isochromen-3-one and 3-phenyl-3,4-dihydro-1H-isochromen-1-one, 7-membered-ring lactones, such as ε-caprolactone, 1,5-dioxepan-2-one, 5-methyloxepan-2-one, oxepane-2,7-dione, thiepan-2-one, 5-chlorooxepan-2-one, (4S)-4-(propan-2-yl)oxepan-2-one, 7-butyloxepan-2-one, 5-(4-aminobutyl)oxepan-2-one, 5-phenyloxepan-2-one, 7-hexyloxepan-2-one, (5S,7S)-5-methyl-7-(propan-2-yl)oxepan-2-one, 4-methyl-7-(propan-2-yl)oxepan-2-one, and lactones with higher numbers of ring members, such as (7E)-oxacycloheptadec-7-en-2-one.

Lactides are cyclic compounds containing two or more ester bonds in the ring. Preferred compounds are glycolide (1,4-dioxane-2,5-dione), L-lactide (L-3,6-dimethyl-1,4-dioxane-2,5-dione), D-lactide, DL-lactide, mesolactide and 3-methyl-1,4-dioxane-2,5-dione, 3-hexyl-6-methyl-1,4-dioxane-2,5-diones, 3,6-di(but-3-en-1-yl)-1,4-dioxane-2,5-dione (in each case inclusive of optically active forms). Particular preference is given to L-lactide.

Cyclic carbonates used are preferably compounds having at least three optionally substituted methylene groups between the oxygen atoms of the carbonate group. Preferred compounds are trimethylene carbonate, neopentyl glycol carbonate (5,5-dimethyl-1,3-dioxan-2-one), 2,2,4-trimethyl-1,3-pentanediol carbonate, 2,2-dimethyl-1,3-butanediol carbonate, 1,3-butanediol carbonate, 2-methyl-1,3-propanediol carbonate, 2,4-pentanediol carbonate, 2-methylbutane-1,3-diol carbonate, TMP monoallyl ether carbonate, pentaerythritol diallyl ether carbonate, 5-(2-hydroxyethyl)-1,3-dioxan-2-one, 5-[2-(benzyloxy)ethyl]-1,3-dioxan-2-one, 4-ethyl-1,3-dioxolan-2-one, 1,3-dioxolan-2-one, 5-ethyl-5-methyl-1,3-dioxan-2-one, 5,5-diethyl-1,3-dioxan-2-one, 5-methyl-5-propyl-1,3-dioxan-2-one, 5-(phenylamino)-1,3-dioxan-2-one and 5,5-dipropyl-1,3-dioxan-2-one. Particular preference is given to trimethylene carbonate and neopentyl glycol carbonate.

Under the conditions of the process of the invention for the copolymerization of epoxides and CO₂, cyclic carbonates having fewer than three optionally substituted methylene groups between the oxygen atoms of the carbonate group are incorporated into the polymer chain not at all or only to a small extent.

However, cyclic carbonates having fewer than three optionally substituted methylene groups between the oxygen atoms of the carbonate group may be used together with other suspension media. Preferred cyclic carbonates having fewer than three optionally substituted methylene groups between the oxygen atoms of the carbonate group are ethylene carbonate, propylene carbonate, 2,3-butanediol carbonate, 2,3-pentanediol carbonate, 2-methyl-1,2-propanediol carbonate and 2,3-dimethyl-2,3-butanediol carbonate.

Cyclic anhydrides used are cyclic compounds containing an anhydride group in the ring. Preferred compounds are succinic anhydride, maleic anhydride, phthalic anhydride, 1,2-cyclohexanedicarboxylic anhydride, diphenic anhydride, tetrahydrophthalic anhydride, methyltetrahydrophthalic anhydride, norbornenedioic anhydride and the chlorination products thereof, succinic anhydride, glutaric anhydride, diglycolic anhydride, 1,8-naphthalic anhydride, succinic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5-dione, 3-methyldihydrofuran-2,5-dione, dihydro-2H-pyran-2,6(3H)-dione, 1,4-dioxane-2,6-dione, 2H-pyran-2,4,6(3H,5H)-trione, 3-ethyldihydrofuran-2,5-dione, 3-methoxydihydrofuran-2,5-dione, 3-(prop-2-en-1-yl)dihydrofuran-2,5-dione, N-(2,5-dioxotetrahydrofuran-3-yl)formamide and 3[(2E)-but-2-en-1-yl]dihydrofuran-2,5-dione. Particular preference is given to succinic anhydride, maleic anhydride and phthalic anhydride.

For the synthesis of the polymer chains of the low-viscosity polyethercarbonate polyols, H-functional starter compounds (starters) are used that have H atoms that are active for the alkoxylation. Alkoxylation-active groups having active H atoms include, for example, —OH, —NH₂ (primary amines), —NH— (secondary amines), —SH, and —CO₂H, preference being given to —OH and —NH₂, particular preference being given to —OH. As H-functional starter compound, use is made, for example, of one or more compounds selected from the group consisting of mono- or polyhydric alcohols, polyfunctional amines, polyfunctional thiols, amino alcohols, thio alcohols, hydroxy esters, polyether polyols, polyester polyols, polyesterether polyols, polyethercarbonate polyols, polycarbonate polyols, polycarbonates, polyethyleneimines, polyetheramines (e.g. so-called Jeffamine® products from Huntsman, such as D-230, D-400, D-2000, T-403, T-3000, T-5000, or corresponding products from BASF, such as Polyetheramine D230, D400, D200, T403, T5000), polytetrahydrofurans (e.g. PolyTHF® from BASF, such as PolyTHF® 250, 650S, 1000, 1000S, 1400, 1800, 2000), polytetrahydrofuranamines (BASF product Polytetrahydrofuranamine 1700), polyetherthiols, polyacrylate polyols, the mono- or diglyceride of ricinoleic acid, monoglycerides of fatty acids, chemically modified mono-, di- and/or triglycerides of fatty acids, and C1-C24 alkyl fatty acid esters which contain on average 2 OH groups per molecule. The C1-C24 alkyl fatty acid esters which contain on average 2 OH groups per molecule are for example commercial products such as Lupranol Balance® (from BASF AG), Merginol® products (from Hobum Oleochemicals GmbH), Sovermol® products (from Cognis Deutschland GmbH & Co. KG), and Soyol®™ products (from USSC Co.).

Monofunctional starter compounds used may be alcohols, amines, thiols and carboxylic acids. Monofunctional alcohols used may be: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, tert-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Suitability as H-functional starter compounds may be ascribed to dihydric alcohols (such as, for example, ethylene glycol, diethylene glycol, propylene glycol, dipropylene glycol, 1,3-propanediol, 1,4-butanediol, 1,4-butenediol, 1,4-butynediol, neopentyl glycol, 1,5-pentanediol, methylpentanediols (such as 3-methyl-1,5-pentanediol, for example), 1,6-hexanediol, 1,8-octanediol, 1,10-decanediol, 1,12-dodecanediol, bis(hydroxymethyl)cyclohexanes (such as 1,4-bis(hydroxymethyl)cyclohexane, for example), triethylene glycol, tetraethylene glycol, polyethylene glycols, dipropylene glycol, tripropylene glycol, polypropylene glycols, dibutylene glycol and polybutylene glycols, and also all modification products of these aforementioned alcohols with different amounts of ε-caprolactone.

The H-functional starter compounds may also be selected from the substance class of the polyether polyols, especially those having a molecular weight Mₙ in the range from 100 to 4000 g/mol. Preference is given to polyether polyols formed from repeat ethylene oxide and propylene oxide units, preferably having a proportion of propylene oxide units of 35% to 100%, particularly preferably having a proportion of propylene oxide units of 50% to 100%. These may be random copolymers, gradient copolymers, alternating copolymers or block copolymers of ethylene oxide and propylene oxide. Suitable polyether polyols composed of repeating propylene oxide and/or ethylene oxide units are, for example, the Desmophen®, Acclaim®, Arcol®, Baycoll®, Bayfill®, Bayflex® Baygal®, PET® and polyether polyols from Bayer MaterialScience AG (for example, Desmophen® 3600Z, Desmophen® 1900U, Acclaim® Polyol 2200, Acclaim® Polyol 4000, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are, for example, the Pluriol® E products from BASF SE, suitable homopolypropylene oxides are, for example, the Pluriol® P products from BASF SE, and suitable mixed copolymers of ethylene oxide and propylene oxide are, for example, the Pluronic® PE or Pluriol® RPE products from BASF SE.

The H-functional starter compounds may also be selected from the substance class of the polyester polyols, especially those having a molecular weight Mₙ in the range from 200 to 4500 g/mol. Polyester polyols used may be at least difunctional polyesters. Preferably, polyester polyols consist of alternating acid and alcohol units. The acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, or mixtures of the stated alcohols. Where dihydric polyether polyols are used as alcohol component, the product comprises polyesterether polyols, which may likewise serve as starter compounds for preparing the polyethercarbonate polyols. Preference is given to using polyether polyols with Mₙ=150 to 2000 g/mol for preparation of the polyesterether polyols.

As H-functional starter compounds it is possible, furthermore, to use polycarbonate diols, more particularly those having a molecular weight Mₙ in the range from 150 to 4500 g/mol, preferably 500 to 2500 g/mol, which are prepared, for example, by reaction of phosgene, dimethyl carbonate, diethyl carbonate or diphenyl carbonate and difunctional alcohols or polyester polyols or polyether polyols. Examples of polycarbonates may be found, for example, in EP-A 1359177. Examples of polycarbonate diols that may be used include the Desmophen® C range from Bayer MaterialScience AG, for example Desmophen® C 1100 or Desmophen® C 2200.

In a further embodiment of the invention, polyethercarbonate polyols and/or polyetherestercarbonate polyols can be used as H-functional starter compounds. It is possible more particularly to use polyetherestercarbonate polyols which are obtainable by the process usable in accordance with the invention that is described here. For this purpose, these polyetherestercarbonate polyols used as H-functional starter compounds are prepared in a separate reaction step beforehand.

The H-functional starter compounds generally have an OH functionality (i.e., number of polymerization-active H atoms per molecule) of 0.8 to 3, preferably of 0.9 to 2.1, and more preferably of 0.95 to 2.05. The H-functional starter compounds are used either individually or as a mixture of at least two H-functional starter compounds.

Preferred H-functional starter compounds are alcohols having a composition according to the general formula (III),

HO—(CH₂)x—OH (III)

where x is a number from 1 to 20, preferably an integer from 2 to 20. Examples of alcohols of formula (III) are ethylene glycol, 1,4-butanediol, 1,6-hexanediol, 1,8-octanediol, 1,10-decanediol, and 1,12-dodecanediol. Further preferred H-functional starter compounds are neopentyl glycol and reaction products of the alcohols of formula (III) with ε-caprolactone. Additionally preferred as H-functional starter compounds are water, diethylene glycol, dipropylene glycol, and polyether polyols composed of repeating polyalkylene oxide units.

With particular preference the H-functional starter compounds comprise one or more compounds selected from the group consisting of ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, difunctional polyetherpolyols, the polyether polyol being synthesized from a di-H-functional starter compound and propylene oxide or from a di-H-functional starter compound, propylene oxide and ethylene oxide. The polyether polyols have an OH functionality of 0.9 to 2.1 and a molecular weight Mₙ in the range from 62 to 4500 g/mol and more particularly a molecular weight Mₙ in the range from 62 to 3000 g/mol.

The catalyst used for the preparation of the low-viscosity polyethercarbonate polyols of the invention having side chains is preferably a DMC catalyst (double metal cyanide catalyst). Additionally or alternatively it is also possible to use other catalysts for the copolymerization of alkylene oxides and CO₂ active catalysts, such as zinc carboxylates or cobalt-salen complexes, for example. Examples of suitable zinc carboxylates are zinc salts of carboxylic acids, especially dicarboxylic acids, such as adipic acid or glutaric acid. An overview of the known catalysts for the copolymerization of alkylene oxides and CO₂ is provided for example by Chemical Communications 47 (2011) 141-163.

The double metal cyanide compounds present in the DMC catalysts which can be used with preference in the process of the invention are the reaction products of water-soluble metal salts and water-soluble metal cyanide salts.

Double metal cyanide (DMC) catalysts are known from the prior art for the homopolymerization of alkylene oxides (see, for example, U.S. Pat. Nos. 3,404,109, 3,829,505, 3,941,849, and 5,158,922). DMC catalysts, which are described in, for example, U.S. Pat. No. 5,470,813, EP-A 700 949, EP-A 743 093, EP-A 761 708, WO 97/40086 A1, WO 98/16310 A1, and WO 00/47649 A1, possess a very high activity and allow the preparation of polyethercarbonate polyols at very low catalyst concentrations. A typical example is that of the highly active DMC catalysts which are described in EP-A 700 949 and contain, as well as a double metal cyanide compound (e.g. zinc hexacyanocobaltate(III)) and an organic complex ligand (e.g. tert-butanol), also a polyether having a number-average molecular weight greater than 500 g/mol.

The DMC catalysts which can be used in accordance with the invention are preferably obtained by

(a) reacting in the first step an aqueous solution of a metal salt with the aqueous solution of a metal cyanide salt in the presence of one or more organic complex ligands, e.g. of an ether or alcohol,

(b) with removal in the second step of the solid from the suspension obtained from (α), by means of known techniques (such as centrifugation or filtration),

(c) with optional washing in a third step of the isolated solid with an aqueous solution of an organic complex ligand (for example by resuspending and subsequently reisolating by filtration or centrifugation),

(d) with subsequent drying of the solid obtained, optionally after pulverization, at temperatures of generally 20-120° C. and at pressures of generally 0.1 mbar to standard pressure (1013 mbar), and by, in the first step or immediately after the precipitation of the double metal cyanide compound (second step), adding one or more organic complex ligands, preferably in excess (based on the double metal cyanide compound) and optionally further complex-forming components.

The double metal cyanide compounds included in the DMC catalysts which can be used in accordance with the invention are the reaction products of water-soluble metal salts and water-soluble metal cyanide salts.

For example, an aqueous zinc chloride solution (preferably in excess relative to the metal cyanide salt) and potassium hexacyanocobaltate are mixed and then dimethoxyethane (glyme) or tert-butanol (preferably in excess, relative to zinc hexacyanocobaltate) is added to the resulting suspension.

Metal salts suitable for preparation of the double metal cyanide compounds preferably have a composition according to the general formula (IV),

M(X)n (IV)

where

M is selected from the metal cations Zn²⁺, Fe²⁺, Ni²⁺, Mn²⁺, Co²⁺, Sn²⁺, Sn²⁺, Pb²⁺ and Cu²⁺; M is preferably Zn²⁺, Fe²⁺, Co²⁺ or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have a composition according to the general formula (V),

Mr(X)₃ (V)

where

M is selected from the metal cations Fe³⁺, Al³⁺, Co³⁺ and Cr³⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and

r is 1 when X=halide, hydroxide, carboxylate, cyanate, thiocyanate, isocyanate, isothiocyanate or nitrate,

or suitable metal salts have a composition according to the general formula (VI),

M(X)s (VI)

where

M is selected from the metal cations Mo⁴⁺, V⁴⁺ and W⁴⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have a composition according to the general formula (VII),

M(X)t (VII)

where

M is selected from the metal cations Mo⁶⁺ and W⁶⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparing the double metal cyanide compounds preferably have a composition according to the general formula (VIII),

(Y)aM′(CN)b(A)c (VIII)

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sn²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate and

a, b and c are integers, the values for a, b and c being selected so as to assure electronic neutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds which are present in the DMC catalysts usable in accordance with the invention are compounds having a composition according to the general formula (IX)

Mx[M′x,(CN)y]z (IX)

in which M is defined as in formula (IV) to (VII) and

M′ is defined as in formula (IIX), and

x, x′, y and z are integral and are selected such as to provide for the electron neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6 lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). For example, organic complex ligands used are water-soluble organic compounds having heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, iso-butanol, sec-butanol, tert-butanol, 2-methyl-3-buten-2-ol and 2-methyl-3-butyn-2-ol), compounds which contain both aliphatic or cycloaliphatic ether groups and aliphatic hydroxyl groups (such as ethylene glycol mono-tert-butyl ether, diethylene glycol mono-tert-butyl ether, tripropylene glycol mono-methyl ether, and 3-methyl-3-oxetanemethanol, for example). Extremely preferred organic complex ligands are selected from one or more compounds of the group consisting of dimethoxyethane, tert-butanol 2-methyl-3-buten-2-ol, 2-methyl-3-butyn-2-ol, ethylene glycol mono-tert-butyl ether, and 3-methyl-3-oxetanemethanol.

In the preparation of the DMC catalysts usable in accordance with the invention, use is made optionally of one or more complex-forming components from the classes of compound of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethylcellulose and polyacetals, or of the glycidyl ethers, glycosides, carboxylic esters of polyhydric alcohols, gallic acids or their salts, esters or amides, cyclodextrins, phosphorus compounds, α,β-unsaturated carboxylic esters, or ionic surface-active or interface-active compounds.

In the preparation of the DMC catalysts that can be used in accordance with the invention, preference is given to using the aqueous solutions of the metal salt (e.g. zinc chloride) in the first step in a stoichiometric excess (at least 50 mol %) relative to the metal cyanide salt. This corresponds at least to a molar ratio of metal salt to metal cyanide salt of 2.25:1.00. The metal cyanide salt (e.g. potassium hexacyanocobaltate) is reacted in the presence of the organic complex ligand (e.g. tert-butanol), and a suspension is formed which comprises the double metal cyanide compound (e.g. zinc hexacyanocobaltate), water, excess metal salt, and the organic complex ligand.

The organic complex ligand may be present in the aqueous solution of the metal salt and/or the metal cyanide salt, or it is added directly to the suspension obtained after precipitation of the double metal cyanide compound. It has been found to be advantageous to mix the aqueous solutions of the metal salt and the metal cyanide salt and the organic complex ligand with vigorous stirring. Optionally, the suspension formed in the first step is subsequently treated with a further complex-forming component. The complex-forming component is preferably used in a mixture with water and organic complex ligand. A preferred process for performing the first step (i.e. the preparation of the suspension) is effected using a mixing nozzle, more preferably using a jet disperser, as described, for example, in WO-A 01/39883.

In the second step, the solid (i.e. the precursor of the inventive catalyst) is isolated from the suspension by known techniques, such as centrifugation or filtration.

In a preferred variant, the isolated solids, in a third process step, are then washed with an aqueous solution of the organic complex ligand (for example by resuspension and subsequent reisolation by filtration or centrifugation). In this way, it is possible to remove, for example, water-soluble by-products such as potassium chloride from the inventive catalyst. Preferably, the amount of the organic complex ligand in the aqueous wash solution is between 40% and 80% by weight, based on the overall solution.

Optionally in the third step the aqueous wash solution is admixed with a further complex-forming component, preferably in the range between 0.5% and 5% by weight, based on the overall solution.

It is also advantageous to wash the isolated solids more than once. Washing takes place preferably, in a first washing step (c-1), with an aqueous solution of the unsaturated alcohol (by means, for example, of resuspension and subsequent reisolation by filtration or centrifugation), in order thereby to remove for example water-soluble by-products, such as potassium chloride, from the catalyst of the invention. The amount of the unsaturated alcohol in the aqueous wash solution is more preferably between 40% and 80% by weight, based on the overall solution of the first washing step. In the further washing steps (c-2) either the first washing step is repeated once or several times, preferably from one to three times, or, preferably, a nonaqueous solution, such as a mixture or solution of unsaturated alcohol and further complex-forming component (preferably in the range between 0.5% and 5% by weight, based on the total amount of the wash solution of step (c-2)), is used as the wash solution, and the solid is washed with it once or more than once, preferably from one to three times.

The isolated and optionally washed solid is then dried, optionally after pulverization, at temperatures of 20-100° C. and at pressures of 0.1 mbar to atmospheric pressure (1013 mbar).

One particularly preferred method for isolating the DMC catalysts of the invention from the suspension, by filtration, filtercake washing, and drying, is described in WO-A 01/80994, for example.

The halogen-containing alkylene oxides are preferably α,β-epoxy-γ-haloalkanes of the formula (I)

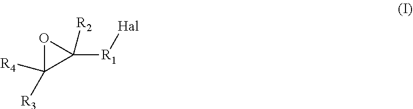

where

Hal is chlorine, bromine or iodine,

R1 is a C1-C22 alkylene radical, preferably a methylene radical, and

R2, R3 and R4 are hydrogen or a C1-C4 alkyl radical, preferably hydrogen.

Preference is given to epichlorohydrin, epibromohydrin and epiiodohydrin, very particular preference to epichlorohydrin.

Halogen-free alkylene oxides are ethylene oxide, propylene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, vinylcyclohexene oxide, cycloheptene oxide, cyclooctene oxide, styrene oxide, methylstyrene oxide, pinene oxide, mono- or polyalkyleneoxidized fats as mono-, di- and triglycerides, alkyleneoxidized fatty acids, C1-C24 esters of alkyleneoxidized fatty acids, epichlorohydrin, derivatives of glycidol, for example methyl glycidyl ether, ethyl glycidyl ether, 2-ethylhexyl glycidyl ether, allyl glycidyl ether, glycidyl methacrylate and alkylene oxide-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane.

Preference is given to ethylene oxide and/or propylene oxide.

In a further embodiment of the process for preparing the polyethercarbonate polyols, the DMC catalyst may be selected from the group encompassing Mx[M′x,(CN)y]z, where: M=Zn(II), Fe(II), Co(II) or Ni(II); M′=Co(III), Fe(U), Cr(III) or Tr(III); and x=3, x′=1, y=6 and z=2. These DMC catalysts have proven particularly advantageous in the context of an effective operating regime in the terpolymerization, in the sense of a high selectivity and a high conversion, even at relatively low temperatures. More particularly it is also possible to use a DMC catalyst comprising zinc hexacyanocobaltate(III).

In a further embodiment of the process of the invention for preparing the polyethercarbonate polyols, the temperature in step (β) may be greater than or equal to 100° C. and less than or equal to 150° C., and in step (γ) may be greater than or equal to 60° C. and less than or equal to 150° C. Step (γ) is carried out, for example, at temperatures of 60 to 150° C., preferably of 80 to 130° C., very preferably of 90 to 120° C. If temperatures below 60° C. are set, the polymerization reaction comes to a standstill. At temperatures above 150° C. the amount of unwanted by-products rises significantly. The temperature in reaction step (γ) is preferably below that of the reaction step (β).

This can lead to rapid activation of the catalyst and to rapid and selective conversion in the polymerization reaction.

In a further embodiment of the process for preparing the polyethercarbonate polyols, carbon dioxide may be metered in likewise in step (β). The metered addition of carbon dioxide in reaction step (β) specifically can lead to better activation of the DMC catalyst, leading in turn to a better yield of the desired main product in the subsequent polymerization step (γ).

In a further embodiment of the process for preparing polyethercarbonate polyols, a cyclic anhydride may be added additionally in step (β) and/or (γ). Through incorporation of the cyclic anhydrides, the resulting polyethercarbonate polyol contains ester groups as well as the ether groups and the carbonate groups. Via the addition of a cyclic anhydride in steps (β) and/or (γ), for example, further functional groups can be incorporated into the polyethercarbonate polyol. For instance, when using unsaturated cyclic anhydrides, double bonds are obtained along the polymer chain. In one preferred embodiment, the cyclic anhydride may comprise maleic anhydride.

In one preferred variant embodiment, the ratio of the carbonate ester groups to ether groups in the polyethercarbonate polyol may be ≥1:20 and ≤1:1, more preferably ≥1:8 and ≤1:2. This ratio for the carbonate ester groups to ether groups has proven particularly advantageous in the context of the operating regime and process economy. Higher fractions of carbonate ester groups may lead to an increased viscosity of the polyethercarbonate polyol.

In one preferred embodiment, the molecular weight Mₙ (determined by gel permeation chromatography) of the polyethercarbonate polyol may be ≥400 and ≤10 000 000 g/mol. In one particularly preferred embodiment, the molecular weight Mₙ may be ≥1000 and ≤1 000 000 g/mol and very preferably ≥2000 and ≤10 000 g/mol. In the context of the process of the invention, this molecular weight range can be prepared efficiently and economically, and the resultant polyethercarbonate polyols exhibit a significantly reduced viscosity by comparison with prior-art polyethercarbonates of comparable molecular weight. This greatly improves the technical handling qualities of the polyethercarbonate polyols of the invention.

In one particular embodiment according to the invention, the OH functionality of the polyethercarbonate polyol may be ≥0.8 and ≤3.0. In addition to the viscosity, the OH functionality of the polymer may be an important parameter for adjusting the reactivity of the polyethercarbonate polyols in further conversion reactions. In comparison to their counterparts without side chains, the polyethercarbonate polyols of the invention have a lower viscosity for a given OH number, thereby enhancing the technical handling qualities.

In a further embodiment, the fraction of the halogenated alkylene oxide incorporated into the polyethercarbonate polyol may be ≥1 mol % and ≤99 mol %.

In one preferred variant embodiment of the polyethercarbonate polyol, the halogen-containing and the halogen-free alkylene oxides may have a nonuniform distribution within the polyethercarbonate polyol. By means of the process of the invention it is possible on the one hand to prepare homogeneous, symmetrical terpolymers which are formed, for example, from a middle structural unit, formed from a difunctional starter molecule, and two structural units linking to it and consisting of terpolymers (see scheme (XI)):

Terpolymer-Starter-Terpolymer (XI)

For the preparation of this kind of terpolymer, the composition of the monomer mixture is kept constant during the polymerization stage. On the other hand, the process of the invention can also be used in principle to produce block terpolymers, consisting for example of a middle structural unit, formed from a difunctional starter molecule, and terpolymer units linking to it and each having different constructions (see scheme (XII)).

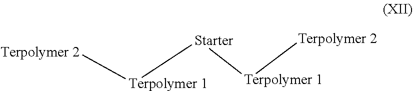

For the preparation of the block terpolymers, for example, the composition of the monomer mixture can be varied during the polymerization stage. In this way it is possible, for example, to obtain sections only with bulky side chains, and sections entirely without side chains. Also conceivable are gradient polymers in which the incorporation of the different monomer species changes continuously over the course of the chain. In addition, of course, the change in the monomer concentration in the course of operation may be more frequent, allowing in principle the synthesis of a polymer having an arbitrary number of different blocks. This flexibility in the process and in the polyethercarbonate polyols of the invention can lead to a much greater facility in fine-tuning of the polymer and hence of the polymer properties to its intended technical service properties.

The halogen-containing polyethercarbonate polyols of the invention may be used, furthermore, as starters for further polymerization steps, such as a subsequent reaction with alkylene oxides or with alkylene oxides and carbon dioxide, for example.

In the subsequent reaction of the terminal OH groups with difunctional chain extenders, such as diisocyanates for example, the halogen-containing polyethercarbonate polyols of the invention form linear chains. In the subsequent reaction with crosslinking reagents of relatively high functionality, such as isocyanates, for example, the halogen-containing polyethercarbonate polyols of the invention form networks which have elastomeric or thermoset character according to whether the service temperature is above or below the glass transition temperature. Following further reaction, the elastomers may be processed to moldings or sheetlike structures (coatings, films). In all of these embodiments, the use of polyethercarbonate polyols of low viscosity in comparison to the prior art results in a significant improvement in the technical manageability.

In one inventive embodiment of the above use, therefore, the polyethercarbonate polyol is reacted with di- and/or polyisocyanates. The low-viscosity polyethercarbonate polyols with side chains that are obtainable by the process of the invention can be processed without problems, in particular by reaction with di- and/or polyisocyanates, to form polyurethanes, more particularly to form flexible polyurethane foams, rigid polyurethane foams, polyurethane elastomers, or polyurethane coatings. The halogen-containing or phosphorus-containing polyethercarbonate polyols of the invention can also be used as internal plasticizers for PVC and rubbers, for example, especially for NBR and CR rubbers. The use of the polyethercarbonate polyols of the invention in the production of such materials comprising thermoset or elastomeric networks leads to an improvement in the physical material properties, such as reduced freezing temperature, increased shape alteration capacity, increased elastic properties, reduced hardness, possibly increased adhesion, and improved processing properties, for example. Without being tied to a theory, this is attributed to the effect of the side chains as internal plasticizers. For rubbers which include low-viscosity polyethercarbonate polyols as plasticizers, there are a multiplicity of possible applications in the industrial rubber sector, particularly as material for cable sheathing, hoses, seals, membranes, footwear soles, floor coverings, and damping equipment. As a result of the use of such internal plasticizers, the materials produced from the polyethercarbonate polyols remain permanently flexible and there is no outward diffusion of the plasticizer.

Accordingly, the halogen-containing polyethercarbonate polyol of the invention can be used in detergent and cleaning product formulations, as plasticizers, drilling fluids, fuel additives, ionic and nonionic surfactants, lubricants, process chemicals for papermaking or textiles production, cosmetic formulations, or as pore formers in the manufacture of ceramics. In all of these applications, the use of the polyethercarbonate polyols with side chains affords processing advantages in comparison to the prior-art polyethercarbonate polyol.

A first embodiment of the invention relates to a process for preparing polyoxyalkylenepolyols, comprising the step of reacting an alkylene oxide with carbon dioxide in the presence of an H-functional starter compound and of a double metal cyanide catalyst, characterized in that the reaction is also conducted in the presence of an α,β-epoxy-γ-haloalkane.

A second embodiment of the invention relates to a process according to the first embodiment, wherein the α,β-epoxy-γ-haloalkane comprises epichlorohydrin, epibromohydrin and/or epiiodohydrin, preferably epichlorohydrin.

A third embodiment of the invention relates to a process according to the first or second embodiment, wherein the alkylene oxide comprises ethylene oxide and/or propylene oxide.

A fourth embodiment of the invention relates to a process according to any of the first to third embodiment, wherein the alkylene oxide and the α,β-epoxy-γ-haloalkane are used in a molar ratio of ≥99:1 to ≤50:50, preferably of ≥95:5 to ≤50:50.

A fifth embodiment of the invention relates to a process according to any of the first to fourth embodiment, wherein the H-functional starter compound comprises a polyol.

A sixth embodiment of the invention relates to a process according to any of the first to fifth embodiment, wherein the reaction is conducted in a reactor and

(α) the reactor is initially charged with a suspension medium containing no H-functional groups and

(γ) one or more H-functional starter substances are metered continuously into the reactor during the reaction.

A seventh embodiment of the invention relates to a process according to any of the first to fifth embodiment, wherein, when the suspension medium is initially charged, no H-functional starter substance is initially charged in the reactor or a portion of the H-functional starter substance is initially charged in the reactor.

An eighth embodiment of the invention relates to a process according to the sixth or seventh embodiment, wherein, in step (α), the suspension medium is initially charged together with a double metal cyanide catalyst.

A ninth embodiment of the invention relates to a process according to the eighth embodiment, wherein, after step (α),

(β) a portion of alkylene oxide is added to the mixture from step (α) at temperatures of 90 to 150° C., and then the addition of the alkylene oxide is stopped.

A tenth embodiment of the invention relates to a process according to the ninth embodiment, wherein, in step (β),

(β1) in a first activation stage a first portion of alkylene oxide is added under an inert gas atmosphere and

(β2) in a second activation stage a second portion of alkylene oxide is added under a carbon dioxide atmosphere.

An eleventh embodiment of the invention relates to a process according to any of the sixth to tenth embodiment, wherein the metered addition of the H-functional starter substances in step (γ) is ended before the addition of the alkylene oxide.

A twelfth embodiment of the invention relates to a process according to any of the sixth to eleventh embodiment, wherein the metered addition of the α,β-epoxy-γ-haloalkane and of the carbon dioxide in step (γ) is simultaneous.

A thirteenth embodiment of the invention relates to a polyoxyalkylenepolyol obtainable by a process according to any of the first to twelfth embodiment.

A fourteenth embodiment of the invention relates to a polyoxyalkylenepolyol according to the thirteenth embodiment having a content of units originating from the α,β-epoxy-γ-haloalkane of ≥1 mol % to ≤30 mol %, preferably of ≥3 mol % to ≤15 mol %.

A fifteenth embodiment of the invention relates to a polyurethane polymer obtainable by reaction comprising a polyoxyalkylenepolyol of the invention according to the thirteenth or fourteenth embodiment with an isocyanate component comprising a polyisocyanate.

A sixteenth embodiment of the invention relates to a polyoxyalkylene polymer obtainable from the reaction of a reaction mixture comprising a polyoxyalkylenepolyol according to any of the thirteenth to fifteenth embodiment with addition of an initiator selected from the group of the photoinitiators, metal-activated peroxides and/or redox initiators.

An eighteenth embodiment of the invention relates to a polyoxyalkylenepolyol according to the thirteenth or fourteenth embodiment having a CO2 content of ≥5% by weight to ≤15% by weight.

### EXAMPLES

The invention is more particularly described with reference to the examples which follow but without any intention to limit the invention thereto.

H-functional starter compounds (starters) used:

PET-1 difunctional poly(oxypropylene)polyol having an OH number of 112 mg_{KoH}/g

The DMC catalyst was prepared according to example 6 of WO-A 01/80994.

Epichlorohydrin (ECH), 99% purity, Fluka

Carbon dioxide (CO2), 99.995% purity, Westfalen

Propylene oxide (PO), 99.9% purity, Chemogas GmbH

HDI trimer triisocyanate with an average molar NCO functionality of 3.4

Desmodur N3300 from Covestro AG, equivalent weight 192 g/mol, NCO content 21.7% by weight

DBTL dibutyltin dilaurate from Sigma Aldrich, purity >95%

The 300 ml pressure reactor used in the examples had a height (internal) of 10.16 cm and an internal diameter of 6.35 cm. The reactor was equipped with an electrical heating jacket (maximum heating power 510 watts). The counter-cooling consisted of an immersed tube of external diameter 6 mm which had been bent into a U shape and which projected into the reactor up to 5 mm above the base, and through which cooling water flowed at about 10° C. The water flow was switched on and off by means of a magnetic valve. In addition, the reactor was equipped with an inlet tube and a thermal sensor of diameter 1.6 mm, which projected into the reactor up to 3 mm above the base.

The heating power of the electrical heating jacket during activation [step (β)] was on average about 20% of the maximum heating power. As a result of the closed-loop control, the heating power varied by 5% of the maximum heating power. The occurrence of increased evolution of heat in the reactor, brought about by the rapid reaction of propylene oxide during the activation of the catalyst [step (β)], was observed via reduced heating power of the heating jacket, engagement of the counter-cooling, and, as the case may be, a temperature increase in the reactor. The occurrence of evolution of heat in the reactor, brought about by the continuous reaction of propylene oxide during the reaction [step (γ)], led to a fall in the power of the heating jacket to about 8% of the maximum heating power. As a result of the closed-loop control, the heating power varied by 5% of the maximum heating power.

The hollow shaft stirrer used in the examples was a hollow shaft stirrer in which the gas was introduced into the reaction mixture via a hollow shaft in the stirrer. The stirrer body mounted on the hollow shaft comprised four arms having a diameter of 35 mm and a height of 14 mm. The arm was equipped at each end with two gas outlets of 3 mm in diameter. The turning of the stirrer created a negative pressure such that the gas above the reaction mixture was sucked away and was introduced into the reaction mixture via the hollow shaft of the stirrer.

The reaction mixture was characterized by ¹H-NMR spectroscopy.

The proportion of the unconverted monomers (propylene oxide R_{PO}, epichlorohydrin R_{ECH} in mol %) was determined by means of ¹H NMR spectroscopy. For this purpose, a sample of each reaction mixture obtained after the reaction was dissolved in deuterated chloroform and measured on a Bruker spectrometer (AV400, 400 MHz).

Subsequently, the reaction mixture was diluted with dichloromethane (20 ml) and the solution was passed through a falling-film evaporator. The solution (0.1 kg in 3 h) ran downwards along the inner wall of a tube of diameter 70 mm and length 200 mm which had been heated externally to 120° C., in the course of which the reaction mixture was distributed homogeneously as a thin film on the inner wall of the falling-film evaporator in each case by three rollers of diameter 10 mm rotating at a speed of 250 rpm. Within the tube, a pump was used to set a pressure of 3 mbar. The reaction mixture which had been purified to free it of volatile constituents (unconverted epoxides, cyclic carbonate, solvent) was collected in a receiver at the lower end of the heated tube.

The relevant resonances in the ¹H NMR spectrum (based on TMS=0 ppm) which were used for integration are as follows:

I1: 1.10-1.17 ppm: methyl group of the polyether units, resonance area corresponds to three hydrogen atoms,

I2: 1.25-1.34 ppm: methyl group of the polycarbonate units, resonance area corresponds to three hydrogen atoms,

I3: 1.45-1.48 ppm: methyl group of the cyclic carbonate, resonance area corresponds to three hydrogen atoms

I4: 2.82-3.85 ppm: CH group for free, unreacted epichlorohydrin, resonance area corresponds to one hydrogen atom.

I5: 2.95-3.00 ppm: CH group for free, unreacted propylene oxide, resonance area corresponds to one hydrogen atom.

The molar proportion of the unconverted propylene oxide (R_{PO} in mol %) based on the sum total of the amount of propylene oxide used in the activation and the copolymerization is calculated by the formula:

R_{ECH}=[I4/((I1/3)+(I2/3)+(I3/3)+I4+I5))]×100%

The molar proportion of the unconverted propylene oxide (R_{PO} in mol %) based on the sum total of the amount of propylene oxide used in the activation and the copolymerization is calculated by the formula:

R_{MA}=[(I5/2)/((I1/3)+(I2/3)+(I3/3)+(I4)+(I5/2)+(I7/2))]×100%

The proportion (% by weight) of CO₂ incorporated into the polymer was determined by means of ¹H NMR spectroscopy.

CO₂ incorporation=[I2*102/((I1/3)*58+(I2/3)*102))]×100%

The number-average Mₙ and the weight-average M_{w} of the molecular weight of the resulting polymers was determined by gel permeation chromatography (GPC). The procedure of DIN 55672-1 was followed: “Gel permeation chromatography, Part 1—Tetrahydrofuran as eluent” (SECurity GPC System from PSS Polymer Service, flow rate 1.0 ml/min; columns: 2×PSS SDV linear M, 8×300 mm, 5 μm; RID detector). Polystyrene samples of known molar mass were used for calibration.

The OH number (hydroxyl number) was determined based on DIN 53240-2 but using N-methylpyrrolidone rather than THF/dichloromethane as solvent. A 0.5 molar ethanolic KOH solution was used for titration (endpoint recognition by potentiometry). The test substance used was castor oil with certified OH number. The reporting of the unit in “mg/g” relates to mg[KOH]/g[polyetherthiocarbonatepolyol].

Viscosity was determined on an Anton Paar Physica MCR 501 rheometer. A cone-plate configuration having a separation of 1 mm was selected (DCP25 measurement system). The polythioethercarbonate polyol (0.1 g) was applied to the rheometer plate and subjected to a shear of 0.01 to 1000 l/s at 25° C. and the viscosity was measured every 10 s for 10 min. The figure reported is the viscosity averaged over all measurement points.

For rheological determination of the gel point for the polyurethane polymer the polythioethercarbonate polyols were admixed with an equimolar amount of Desmodur N3300 (hexamethylene diisocyanate trimer) and 2000 ppm of dibutyltin laurate (2% in diphenyl ether). The complex moduli G′ (storage modulus) and G″ (loss modulus) were determined in an oscillation measurement at 40° C. and a frequency of 1 Hz, using a plate/plate configuration with a plate diameter of 15 mm, a plate-to-plate distance of 1 mm, and a 10 percent deformation. The gel point was defined as the time at which G′=G″.

### Example 1: Preparation of a Halogen-Containing Polyoxyalkylenecarbonate Polyol by Polymerization of Propylene Oxide, 13.5 Mol % of Epichlorohydrin and CO₂

[First Activation Stage, Step (α)]

A 300 ml pressure reactor fitted with a sparging stirrer was initially charged with a mixture of DMC catalyst (27 mg) and PET-1 (30 g). The reactor was sealed and the pressure in the reactor reduced to 5 mbar for five minutes. The pressure in the reactor was then adjusted to 50 mbar by application of a gentle Ar stream and simultaneous removal of the gas with a pump. The reactor was heated to 130° C. and the mixture was stirred (800 rpm) at 130° C. under reduced pressure (50 mbar) and a gentle Ar stream for 30 minutes. [Second activation stage, step (β)]

CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 3.0 g of propylene oxide were metered in with the aid of an HPLC pump (1 ml/min) and the reaction mixture was stirred (800 rpm) for 20 min. The occurrence of a brief increase in evolution of heat in the reactor during this time indicated the activation of the catalyst. Subsequently, two further portions each of 3.0 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst.

[Polymerization Stage, Step (γ)]

After cooling to 105° C., a further 38.0 g of propylene oxide were metered in by means of an HPLC pump (0.91 ml/min) with continued stirring. 10.5 min after commencement of the addition of propylene oxide, 12 g of epichlorohydrin were simultaneously metered in by means of an HPLC pump (0.26 ml/min). The reaction mixture was then stirred at 105° C. for a further 1 h. The reaction was stopped by cooling the reactor with ice water, the positive pressure was released and the resulting product analyzed.

The molar proportion of unconverted propylene oxide (R_{PO} in mol %) was 4.0%, and that of unconverted epichlorohydrin (R_{ECH} in mol %) was 3.0 mol %.

The CO₂ content incorporated in the polyether ester carbonate polyol, the ratio of carbonate to ether units, the molecular weight obtained, the polydispersity index (PDI) and the OH number are reported in table 1.

### Example 2: Preparation of a Halogen-Containing Polyoxyalkylenecarbonate Polyol by Polymerization of Propylene Oxide, 6.5 Mol % of Epichlorohydrin and CO₂

[First Activation Stage, Step (α)]

A 300 ml pressure reactor fitted with a sparging stirrer was initially charged with a mixture of DMC catalyst (27 mg) and PET-1 (30 g). The reactor was sealed and the pressure in the reactor reduced to 5 mbar for five minutes. The pressure in the reactor was then adjusted to 50 mbar by application of a gentle Ar stream and simultaneous removal of the gas with a pump. The reactor was heated to 130° C. and the mixture was stirred (800 rpm) at 130° C. under reduced pressure (50 mbar) and a gentle Ar stream for 30 minutes. [Second activation stage, step (β)]

CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 3.0 g of propylene oxide were metered in with the aid of an HPLC pump (1 ml/min) and the reaction mixture was stirred (800 rpm) for 20 min. The occurrence of a brief increase in evolution of heat in the reactor during this time indicated the activation of the catalyst. Subsequently, two further portions each of 3.0 g of propylene oxide were metered in by means of the HPLC pump (1 ml/min) and the reaction mixture was stirred for 20 min (800 rpm). The occurrence of a brief increase in evolution of heat in the reactor during this time confirmed the activation of the catalyst.

[Polymerization Stage, Step (γ)]

After cooling to 105° C., a further 45.0 g of propylene oxide were metered in by means of an HPLC pump (0.91 ml/min) with continued stirring. 10.5 min after commencement of the addition of propylene oxide, 6.0 g of epichlorohydrin were simultaneously metered in by means of an HPLC pump (0.26 ml/min). The reaction mixture was then stirred at 105° C. for a further 1 h. The reaction was stopped by cooling the reactor with ice water, the positive pressure was released and the resulting product analyzed.

The molar proportion of unconverted propylene oxide (R_{PO} in mol %) was 1.4%, and that of unconverted epichlorohydrin (R_{ECH} in mol %) was 1.1 mol %.

The CO₂ content incorporated in the polyether ester carbonate polyol, the ratio of carbonate to ether units, the molecular weight obtained, the polydispersity index (PDI) and the OH number are reported in table 1.

### Example 3 (Comparative): Attempted Preparation of a Halogen-Containing Polyoxyalkylene Polyol by Polymerization of Propylene Oxide and 13.5 Mol % of Epichlorohydrin

[First Activation Stage, Step (α)]

A 300 ml pressure reactor fitted with a sparging stirrer was initially charged with a mixture of DMC catalyst (27 mg) and PET-1 (30 g). The reactor was sealed and the pressure in the reactor reduced to 5 mbar for five minutes. The pressure in the reactor was then adjusted to 50 mbar by application of a gentle Ar stream and simultaneous removal of the gas with a pump. The reactor was heated to 130° C. and the mixture was stirred (800 rpm) at 130° C. under reduced pressure (50 mbar) and a gentle Ar stream for 30 minutes.

[Second Activation Stage, Step (β)]

A pressure of 2 bar of Ar was established. 3.0 g of propylene oxide were metered in with the aid of an HPLC pump (1 ml/min) and the reaction mixture was stirred (800 rpm) for 20 min. The occurrence of a brief increase in evolution of heat in the reactor during this time indicated the activation of the catalyst. Subsequently, two further portions each of 3.0 g of propylene oxide were metered in by means of the HPLC pump (1 ml/min) and the reaction mixture was stirred for 20 min (800 rpm). The occurrence of a brief increase in evolution of heat in the reactor during this time confirmed the activation of the catalyst.

[Polymerization Stage, Step (γ)]

After cooling to 105° C., a further 39.0 g of propylene oxide were metered in by means of an HPLC pump (0.91 ml/min) with continued stirring. 10.5 min after commencement of the addition of propylene oxide, 12.0 g of epichlorohydrin were simultaneously metered in by means of an HPLC pump (0.26 ml/min). The reaction mixture was then stirred at 105° C. for a further 1 h. Ten minutes after the start of the addition of epichlorohydrin, the reaction was stopped by cooling the reactor with ice-water, since no reaction was observed.

### Example 4 (Comparative): Attempted Preparation of a Halogen-Containing Polyoxyalkylene Polyol by Polymerization of Epichlorohydrin

[First Activation Stage, Step (α)]

A 300 ml pressure reactor fitted with a sparging stirrer was initially charged with a mixture of DMC catalyst (27 mg) and PET-1 (30 g). The reactor was sealed and the pressure in the reactor reduced to 5 mbar for five minutes. The pressure in the reactor was then adjusted to 50 mbar by application of a gentle Ar stream and simultaneous removal of the gas with a pump. The reactor was heated to 130° C. and the mixture was stirred (800 rpm) at 130° C. under reduced pressure (50 mbar) and a gentle Ar stream for 30 minutes.

[Second Activation Stage, Step (β)]

Ar was injected to 2 bar. 3.0 g of epichlorohydrin were metered in with the aid of an HPLC pump (1 ml/min) and the reaction mixture was stirred (800 rpm) for 20 min. There was no occurrence of a brief increase in evolution of heat in the reactor during this time that would have indicated activation of the catalyst. Subsequently, two further portions each of 3.0 g of epichlorohydrin were metered in by means of the HPLC pump (1 ml/min) and the reaction mixture was stirred for 20 min (800 rpm). The reaction was stopped by cooling the reactor with ice-water since no reaction was observed.

TABLE
Overview of the results of the preparation of polyoxyalkylenecarbonate polyols

| | | CO₂ | ECH | | | OH |
|---|---|---|---|---|---|---|
| | Reaction | incorporation | incorporation | Mₙ | | number |
| Example | [—] | [% by wt.] | [mol %] | [g/mol] | PDI | [mg_{KOH} · g⁻¹] |
| 1 | Terpolymerization of | 7.7 | 5.8 | 3286 | 1.21 | 40.2 |
| | PO/13.5 mol % ECH/CO₂ | | | | | |
| 2 | Terpolymerization of | 9.2 | 3.2 | 3324 | 1.23 | 46.0 |
| | PO/6.5 mol % ECH/CO₂ | | | | | |

| | | |
|---|---|---|
| 3 | Copolymerization of | No product was obtained. |
| (comp.) | PO/13.5 mol % ECH | |
| 4 | Homopolymerization of | No product was obtained. |
| (comp.) | ECH | |

Comp.: comparative example
ECH: epichlorohydrin

Comparative examples 3-4 demonstrate that, in the case of copolymerization in the presence of epichlorohydrin and in the absence of carbon dioxide, no polymer is formed in the polymerization catalyzed by DMC catalyst. As shown by examples 1-2, the DMC catalyst used, when the monomer mixture contains epichlorohydrin, is active only when carbon dioxide is additionally used as comonomer.

### Example 5: Preparation of a Polyurethane Using a Polyoxyalkylenecarbonate Polyol from Example 1 (PEC-1) and HDI Trimer

PEC-1 (2.0 g), HDI (276 mg) and DBTL (1% by weight, 22.8 mg) were mixed in an aluminum beaker. Subsequently, a sample of the mixture (0.4 g) was used for the measurement on the rheometer and was heated to 40° C. for three hours.

The NCO index was 1.0.

The gel time was 17.2 min.

### Example 6: Preparation of a Polyurethane Using a Polyoxyalkylenecarbonate Polyol from Example 2 (PEC-2) and HDI Trimer

PEC-2 (2.0 g), HDI (317 mg) and DBTL (1% by weight, 23.2 mg) were mixed in an aluminum beaker. Subsequently, a sample of the mixture (0.4 g) was used for the measurement on the rheometer and was heated to 60° C. for three hours.

The NCO index was 1.0. The gel time was 15.3 min.

1. A process for preparing polyoxyalkylenepolyols, comprising reacting an alkylene oxide with carbon dioxide in the presence of an H-functional starter compound and of a double metal cyanide catalyst, and an α,β-epoxy-γ-haloalkane.

2. The process as claimed in claim 1, wherein the α,β-epoxy-γ-haloalkane comprises at least one of epichlorohydrin, epibromohydrin and epiiodohydrin.

3. The process as claimed in claim 1, wherein the alkylene oxide comprises ethylene oxide and/or propylene oxide.

4. The process as claimed in claim 1, wherein the alkylene oxide and the α,β-epoxy-γ-haloalkane are used in a molar ratio of ≥99:1 to ≤50:50.

5. The process as claimed in claim 1, wherein the H-functional starter compound comprises a polyol.

6. The process as claimed in claim 1, wherein the reaction is conducted in a reactor and comprises
(α) initially charging the reactor with a suspension medium containing no H-functional groups, and
(γ) continuously metering one or more H-functional starter substances into the reactor during the reaction.

7. The process as claimed in claim 6, wherein, in (α) when the suspension medium is initially charged, no H-functional starter substance is initially charged in the reactor or a portion of the H-functional starter substance is initially charged in the reactor.

8. The process as claimed in claim 6, wherein, in (α), the suspension medium is initially charged together with a double metal cyanide catalyst.

9. The process as claimed in claim 8, wherein (α) is followed by
(β) adding a portion of alkylene oxide to the mixture from (α) at temperatures of 90 to 150° C., and then stopping the addition of the alkylene oxide.

10. The process as claimed in claim 9, wherein, in (β),
(β1) adding a first portion of alkylene oxide in a first activation stage under an inert gas atmosphere and
(β2) adding a second portion of alkylene oxide in a second activation stage under a carbon dioxide atmosphere.

11. The process as claimed in claim 6, wherein the continuously metered addition in (γ) of the H-functional starter substances in (γ) is ended before the addition of the alkylene oxide.

12. The process as claimed in claim 6, wherein the continuously metered addition of the α,β-epoxy-γ-haloalkane and of the carbon dioxide in (γ) is simultaneous.

13. A polyoxyalkylenepolyol obtainable by a process as claimed in claim 1.

14. A polyoxyalkylenepolyol as claimed in claim 13 having a content of units originating from the α,β-epoxy-γ-haloalkane of ≥1 mol % to ≤30 mol %.

15. A polyurethane polymer obtainable from the reaction of a polyol component comprising a polyoxyalkylenepolyol as claimed in claim 13 with at least one polyisocyanate component.

16. The process as claimed in claim 4, wherein the alkylene oxide and α,β-epoxy-γ-haloalkane are used in a molar ratio of ≥95:5 to ≤50:50.

17. The polyoxyalkylene polyol as claimed in claim 14 having a content of units originating from the α,β-epoxy-γ-haloalkane of ≥3 mol % to ≤15 mol %.
